(19) United States
(12) Patent Application Publication
(10) Pub. No.: US 2020/0317860 A1
(43) Pub. Date: Oct. 8, 2020

(54) METHOD FOR PRODUCING POLYETHERESTER POLYOLS

(71) Applicant: Covestro Deutschland AG, Leverkusen (DE)

(72) Inventors: Markus Meuresch, Köln (DE); Aurel Wolf, Wülfrath (DE); Christoph Guertler, Köln (DE)

(21) Appl. No.: 16/766,840

(22) PCT Filed: Dec. 12, 2018
(86) PCT No.: PCT/EP2018/084486

§ 371 Date: May 26, 2020

(30) Foreign Application Priority Data
Dec. 19, 2017 (EP) 17208405.5

(51) Int. Cl. C08G 63/664; C08G 18/42

(52) U.S. Cl. CPC C08G 63/664; C08G 18/72; C08G 18/4261

(57) ABSTRACT

A subject of the invention is a method for producing a polyetherester polyol by addition of alkylene oxide and lactone to H-functional starter substance in the presence of a double metal cyanide catalyst, wherein a suspension medium containing no H-functional groups is first initially charged in a reactor, and an H-functional starter substance is subsequently continuously metered in to the reactor during the reaction, and wherein the lactone is a 4-membered cyclic lactone. A further subject is also the polyetherester polyol obtainable according to the method according to the invention, and also polyurethanes which can be produced therefrom.

The invention relates to a process for preparing a polyether ester polyol by addition of alkylene oxide and lactone onto H-functional starter substance in the presence of a double metal cyanide catalyst, wherein firstly a suspension medium containing no H-functional groups is initially charged in a reactor, an H-functional starter substance is then continuously metered into the reactor over the course of the reaction and wherein the lactone is a 4-membered ring lactone. The invention further provides the polyether ester polyol and obtainable by the process according to the invention and polyurethanes preparable therefrom.

WO2012022048 discloses a process for preparing polyether ester polyols by reaction of an H-functional starter substance with alkylene oxides and lactones in the presence of hybrid catalyst systems having a lactone proportion of 20% by weight, wherein these systems consist of a double metal cyanide catalyst (DMC catalyst) and a further cocatalyst, for example titanium alkoxide. The authors are of the view that the use of pure double metal cyanide catalysts leads to cloudy or layered polyol products as a result of inhomogeneities in the polyol compositions. After reaction of the polyol component with polyisocyanates the latter inhomogeneities lead in the resulting polyurethane elastomer to a poorer swelling behavior for polyether ester polyols produced with double metal cyanide catalysts without cocatalyst versus those with cocatalyst.

U.S. Pat. No. 5,032,671 discloses a process for preparing polyether ester polyols by reaction of an H-functional starter substance with alkylene oxides and lactones in the presence of a double metal cyanide catalyst. This comprises initially charging in the reactor oligomeric, H-functional starter substances together with the DMC catalyst and metering in a mixture of alkylene oxides and lactones for 20 h in a so-called semi-batch mode, thus resulting in reaction times of 20 h and a maximum theoretical ester group fraction in the resulting copolymer of 20% by weight.

The present invention accordingly had for its object to provide a simple and time-efficient process for preparing polyether ester polyols. Commercially available catalysts in the field of polyol synthesis shall ideally also be used to obtain homogenous, single-phase polyol product compositions and avoid inhomogeneities, such as clouding or even demixing processes, which impedes further distribution such as for example in the formation of polyurethanes. The present invention specifically also provides for increasing the ester group fraction in the polyester polyol compared to the processes known from the prior art.

It has been found that, surprisingly, the object of the invention is achieved by a process for preparing a polyether ester polyol by addition of alkylene oxide and lactone onto H-functional starter substance in the presence of a double metal cyanide catalyst, wherein

(α) a suspension medium containing no H-functional groups is initially charged in a reactor,

(γ) H-functional starter substance is continuously metered into the reactor over the course of the reaction and wherein the lactone is a 4-membered ring lactone.

In the process according to the invention firstly a suspension medium containing no H-functional groups is initially charged in the reactor. Subsequently, the amount of DMC catalyst required for the polyaddition, preferably in unactivated form, is added to the reactor. The sequence of addition is not critical here. It is also possible to charge the reactor firstly with the DMC catalyst and subsequently with the suspension medium. It is alternatively also possible to suspend the DMC catalyst in the inert suspension medium first and to charge the reactor with the suspension subsequently. The suspension medium provides an adequate heat exchange area with the reactor wall or cooling elements installed in the reactor and the liberated heat of reaction can therefore be removed very efficiently. Moreover, the suspension medium, in the event of a cooling failure, provides heat capacity, such that the temperature in this case can be kept below the breakdown temperature of the reaction mixture.

The suspension media used in accordance with the invention do not contain any H-functional groups. Suitable suspension media are all polar aprotic, weakly polar aprotic and nonpolar aprotic solvents, containing no H-functional groups in each case. Suspension media used may also be a mixture of two or more of these suspension media. The following polar aprotic solvents are mentioned here by way of example: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferably employed suspension media include 4-methyl-2-oxo-1,3-dioxolane, 1,3-dioxolan-2-one, toluene, xylene, ethylbenzene, chlorobenzene and dichlorobenzene and mixtures of two or more of these suspension media, 4-methyl-2-oxo-1,3-dioxolane and 1,3-dioxolan-2-one or a mixture of 4-methyl-2-oxo-1,3-dioxolane and 1,3-dioxolan-2-one are particularly preferred.

Step (α):

Preferably, in step (a) a suspension medium containing no H-functional groups is initially charged in the reactor, optionally together with DMC catalyst, and no H-functional starter substance is initially charged in the reactor at this time. Alternatively, it is also possible in step (a) to initially charge the reactor with a suspension medium containing no H-functional groups, and additionally with a portion of the H-functional starter substance(s) and optionally with DMC catalyst.

The DMC catalyst is preferably used in an amount such that the content of DMC catalyst in the resulting reaction product is 10 to 10 000 ppm, more preferably 20 to 5000 ppm, and most preferably 50 to 2000 ppm.

In a preferred embodiment, an inert gas (for example argon or nitrogen) is introduced into the resulting mixture of suspension medium and DMC catalyst at a temperature of 90° C. to 150° C., more preferably of 100° C. to 140° C., and at the same time a reduced pressure (absolute) of 10 mbar to 800 mbar, more preferably of 50 mbar to 200 mbar, is applied.

In an alternative preferred embodiment, the resulting mixture of suspension medium and DMC catalyst is subjected at least once, preferably three times, at a temperature of 90° C. to 150° C., more preferably of 100° C. to 140° C. to 1.5 bar to 10 bar (absolute), more preferably 3 bar to 6 bar (absolute), of an inert gas (for example argon or nitrogen) and then the positive pressure is reduced in each case to about 1 bar (absolute).

The DMC catalyst can be added in solid form or as a suspension in a suspension medium or in a mixture of at least two suspension media.

In a further preferred embodiment, in step (a),
(α-I) the suspension medium or a mixture of at least two suspension media is initially charged and
(α-II) the temperature of the suspension medium or the mixture of at least two suspension media is brought to 50° C. to 200° C., preferably 80° C. to 160° C., more preferably 100° C. to 140° C., and/or the pressure in the reactor is reduced to less than 500 mbar, preferably 5 mbar to 100 mbar, in the course of which an inert gas stream (for example of argon or nitrogen) is optionally passed through the reactor,

wherein the double metal cyanide catalyst are added to the suspension medium or to the mixture of at least two suspension media in step (α-I) or immediately thereafter in step (α-II), and wherein the suspension medium contains no H-functional groups.

Step (β):

Step (β) serves for activation of the DMC catalyst. This step can optionally be carried out in an inert gas atmosphere. In the context of the invention activation is to be understood as meaning a step in which a portion of alkylene oxide compound or a mixture of alkylene oxide compound and lactone is added to the DMC catalyst suspension at temperatures of 90° C. to 150° C. and then the addition of the alkylene oxide compound or a mixture of alkylene oxide compound and lactone is interrupted, a subsequent exothermic chemical reaction causing an evolution of heat to be observed which can lead to a temperature spike (“hotspot”) and the reaction of alkylene oxide or a mixture of alkylene oxide compound and lactone causing a pressure drop to be observed in the reactor. The process step of activation is the period from the addition of the portion of alkylene oxide compound, or a mixture of alkylene oxide compound and lactone, to the DMC catalyst until onset of heat evolution. The portion of alkylene oxide compound or a mixture of alkylene oxide compound and lactone may be added to the DMC catalyst in several individual steps, the addition of the alkylene oxide compound or a mixture of alkylene oxide compound and lactone then being interrupted in each case. In this case the process step of activation comprises the period from the addition of the first portion of alkylene oxide compound or a mixture of alkylene oxide compound and lactone to the DMC catalyst until onset of heat evolution after addition of the last portion of alkylene oxide compound or a mixture of alkylene oxide compound and lactone. In general, the activation step may be preceded by a step for drying the DMC catalyst and optionally the H-functional starter substance at elevated temperature and/or reduced pressure, optionally with passage of an inert gas through the reaction mixture.

The metered addition of one or more alkylene oxides or a mixture of alkylene oxide compound and lactone may in principle be carried out in different ways. The metered addition can be started from the vacuum or at a preselected supply pressure. The supply pressure is preferably established by introduction of an inert gas (for example nitrogen or argon), wherein the (absolute) pressure is 5 mbar to 100 bar, preferably 10 mbar to 50 bar and more preferably 20 mbar to 50 bar.

In a preferred embodiment, the amount of one or more alkylene oxides or a mixture of alkylene oxide compound and lactone used in the activation in step (β) is 0.1% to 25.0% by weight, preferably 1.0% to 20.0% by weight, more preferably 2.0% to 16.0% by weight (based on the amount of suspension medium used in step (a)). The alkylene oxide or a mixture of alkylene oxide compound and lactone may be added in one step or portionwise in two or more portions. It is preferable when after addition of a portion of alkylene oxide compound or a mixture of alkylene oxide compound and lactone the addition of the alkylene oxide compound or a mixture of alkylene oxide compound and lactone is interrupted until onset of heat evolution, the next portion of alkylene oxide compound or a mixture of alkylene oxide compound and lactone being added only then.

Step (γ):

The metered addition of one or more H-functional starter substance(s) and of a mixture of alkylene oxide compound and lactone may be carried out simultaneously or sequentially (portionwise), for example the amount of H-functional starter substances and/or the amount of a mixture of alkylene oxide compound and lactone metered in in step (γ) may be added all at once or continuously. The term “continuously” as used here can be defined as a mode of addition of a reactant such that a concentration of the reactant effective for the copolymerization is maintained, meaning that, for example, the metered addition may be carried out at a constant metered addition rate, at a varying metered addition rate or portionwise.

It is possible to meter in the mixture of alkylene oxide compound and lactone at a constant metered addition rate or to increase or decrease the metered addition rate gradually or stepwise or to add the mixture of alkylene oxide compound and lactone and/or further alkylene oxide compound and/or lactone portionwise. The alkylene oxide or a mixture of alkylene oxide compound and lactone is preferably added to the reaction mixture at a constant metered addition rate. If two or more alkylene oxides and/or lactones are used for synthesis of the polyether ester polyols, the alkylene oxides and/or lactones may be metered in individually or as a mixture. The metered addition of the alkylene oxide compound, the lactone and the H-functional starter substances may be effected simultaneously or sequentially via separate feeds (additions) in each case or via one or more feeds, wherein the alkylene oxides, lactones and the H-functional starter substances may be metered in individually or as a mixture. It is possible via the manner and/or sequence of the metered addition of the H-functional starter substances, the alkylene oxides and/or the lactone to synthesize random, alternating, block or gradient polyether ester polyols.

In a preferred embodiment, in step (γ) the metered addition of the one or more H-functional starter substance(s) is terminated prior to the addition of the alkylene oxide.

One characteristic feature of a preferred embodiment of the process of the invention is that, in step (γ), the total amount of the one or more H-functional starter substance(s) is added. This addition may be effected at a constant metered addition rate, at a varying metered addition rate or portionwise.

For the process according to the invention it has further been found that the copolymerization (step (γ)) for preparing the polyether ester polyols is advantageously performed at 50° C. to 150° C., preferably at 60° C. to 145° C., more preferably at 70° C. to 140° C. and most preferably at 90° C. to 130° C. If temperatures are set below 50° C. the reaction generally becomes very slow. At temperatures above 150° C., there is a sharp rise in the quantity of unwanted by-products.

The metered addition of the alkylene oxide, the H-functional starter substance and the DMC catalyst may be effected via separate or combined feed points. In a preferred embodiment, the alkylene oxide and the H-functional starter substance are continuously supplied to the reaction mixture via separate feed points. This addition of the one or more H-functional starter substance(s) can be effected as a continuous metered addition into the reactor or portionwise.

Steps (α), (β) and (γ) may be performed in the same reactor or may each be performed separately in different reactors. Particularly preferred reactor types are: tubular reactors, stirred tanks, loop reactors.

Polyether ester polyols may be prepared in a stirred tank, the stirred tank being cooled via the reactor jacket, internal cooling surfaces and/or cooling surfaces within a pumped circulation circuit, depending on the embodiment and mode of operation. Both in the semi-batch application, where the product is withdrawn only once the reaction has ended, and in the continuous application, where the product is withdrawn continuously, particular attention should be paid to the metered addition rate of the alkylene oxide. The concentration of free alkylene oxides in the reaction mixture during the activation step (step β) is preferably >0% to 100% by weight, more preferably >0% to 50% by weight, most preferably >0% to 20% by weight (based in each case on the weight of the reaction mixture). The concentration of free alkylene oxides in the reaction mixture during the reaction (step γ) is preferably >0% to 40% by weight, more preferably >0% to 25% by weight, most preferably >0% to 15% by weight (based in each case on the weight of the reaction mixture).

In a preferred embodiment, the activated DMC catalyst/suspension medium mixture that results according to steps (α) and (β) is further reacted with one or more alkylene oxide(s), one or more starter substance(s) and one or more lactone(s) in the same reactor. In a further preferred embodiment, the activated DMC catalyst/suspension medium mixture that results according to steps (α) and (β) is further reacted with alkylene oxides, one or more starter substance(s) and one or more lactone(s) in another reaction vessel (for example a stirred tank, tubular reactor or loop reactor).

In the case of a reaction conducted in a tubular reactor, the activated catalyst/suspension medium mixture that results according to steps (α) and (β), one or more H-functional starter substance(s), one or more alkylene oxide(s) and one or more lactone(s) are pumped continuously through a tube. The molar ratios of the coreactants vary according to the desired polymer. It is advantageous to install mixing elements for better mixing of the coreactants as are marketed for example by Ehrfeld Mikrotechnik BTS GmbH or mixer-heat exchanger elements which simultaneously improve mixing and heat removal.

It is likewise possible to employ loop reactors for preparation of polyether ester polyols. These generally include reactors with recycling of matter, for example a jet loop reactor, which can also be operated continuously, or a tubular reactor designed in the form of a loop with suitable apparatuses for circulation of the reaction mixture, or a loop of a plurality of series-connected tubular reactors. The use of a loop reactor is therefore advantageous especially because backmixing can be achieved here, such that it is possible to keep the concentration of free alkylene oxides in the reaction mixture within the optimal range, preferably in the range from >0% to 40% by weight, particularly preferably >0% to 25% by weight, most preferably >0% to 15% by weight (based in each case on the weight of the reaction mixture).

Preferably, the polyether ester polyols are prepared in a continuous process which comprises both a continuous copolymerization and a continuous addition of the one or more H-functional starter substance(s).

The invention therefore also provides a process wherein, in step (γ), one or more H-functional starter substance(s), one or more alkylene oxide(s), one or more lactone(s) are reacted and DMC catalyst is continuously metered into the reactor (“copolymerization”) and wherein the resulting reaction mixture (containing the reaction product) is continuously removed from the reactor. It is preferable when in step (γ), the DMC catalyst is continuously added in the form of a suspension in H-functional starter substance.

For example, for the continuous process for preparing the polyether ester polyols in steps (α) and
(β) an activated DMC catalyst/suspension medium mixture is prepared, then, in step (γ),
(γ1) a portion of each of one or more H-functional starter substance(s), one or more alkylene oxide(s) and one or more lactone(s) are metered in to initiate the copolymerization and
(γ2) during the progress of the copolymerization, the remaining amount of each of DMC catalyst, one or more starter substance(s) and alkylene oxide(s) and one or more lactone(s) is metered in continuously, with simultaneous continuous removal of resulting reaction mixture from the reactor.

In step (γ), the DMC catalyst is preferably added in the form of a suspension in the H-functional starter substance, the amount preferably being chosen such that the content of DMC catalyst in the resulting reaction product is 10 to 10 000 ppm, more preferably 20 to 5000 ppm, and most preferably 50 to 2000 ppm.

Preferably, steps (α) and (β) are performed in a first reactor, and the resulting reaction mixture is then transferred into a second reactor for the copolymerization of step (γ). However, it is also possible to perform steps (α), (β) and (γ) in one reactor.

It has also been found that the process of the present invention can be used for preparation of large amounts of the polyether ester polyol product, wherein a DMC catalyst activated according to steps (α) and (β) in a suspension medium is initially used, and the DMC catalyst is added without prior activation during the copolymerization (γ).

A particularly advantageous feature of the preferred embodiment of the present invention is thus the ability to use “fresh” DMC catalysts without activation of the portion of DMC catalyst which is added continuously in step (γ). An activation of DMC catalysts to be performed analogously to step (β) entails not just additional attention from the operator, thus resulting in an increase in manufacturing costs, but also requires a pressure reaction vessel, thus also resulting in an increase in the capital costs in the construction of a corresponding production plant. Here, “fresh” catalyst is defined as unactivated DMC catalyst in solid form or in the form of a slurry in a starter substance or suspension medium. The ability of the present process to use fresh, unactivated DMC catalyst in step (γ) enables significant savings in the commercial preparation of polyether ester polyols and is a preferred embodiment of the present invention.

The term “continuously” used here can be defined as the mode of addition of a relevant catalyst or reactant such that an essentially continuous effective concentration of the DMC catalyst or the reactant is maintained. Catalyst feeding may be effected in a truly continuous manner or in relatively tightly spaced increments. Equally, continuous starter addition may be effected in a truly continuous manner or in increments. There would be no departure from the present process in adding a DMC catalyst or reactants incrementally such that the concentration of the materials added drops essentially to zero for a period of time before the next incremental addition. However, it is preferable for the DMC catalyst concentration to be kept substantially at the same concentration during the main portion of the course of the continuous reaction, and for starter substance to be present during the main portion of the copolymerization process. Incremental addition of DMC catalyst and/or reactant that does not significantly affect the characteristics of the product is nevertheless “continuous” in the sense in which the term is used here. It is possible, for example, to provide a recycling loop in which a portion of the reacting mixture is recycled to a prior point in the process, thus smoothing out discontinuities caused by incremental additions.

Step (δ)

In step (δ) the reaction mixture continuously removed in step (γ) which generally has an alkylene oxide and/or lactone content of from 0.05% by weight to 10% by weight may optionally be transferred into a postreactor in which, by way of a postreaction, the content of free alkylene oxide is reduced to less than 0.05% by weight in the reaction mixture. The postreactor may be a tubular reactor, a loop reactor or a stirred tank for example.

The pressure in this postreactor is preferably at the same pressure as in the reaction apparatus in which reaction step (γ) is performed. However, the pressure in the downstream reactor may also be chosen to be higher or lower and the downstream reactor may be operated at standard pressure or a slight positive pressure. The temperature in the downstream reactor is preferably 50° C. to 150° C. and more preferably 80° C. to 140° C.

The polyether ester polyols obtained in accordance with the invention have a functionality, for example, of at least 1, preferably of 1 to 8, more preferably of 1 to 6 and most preferably of 2 to 4. The molecular weight is preferably 400 to 10 000 g/mol and more preferably 500 to 6000 g/mol.

The process according to the invention may generally employ alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkyloxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Preferably employed alkylene oxides are ethylene oxide and/or propylene oxide, especially propylene oxide.

Suitable H-functional starter substances (“starters”) that may be used are compounds having alkoxylation-active hydrogen atoms and having a molar mass of 18 to 4500 g/mol, preferably of 62 to 500 g/mol and more preferably of 62 to 250 g/mol. The ability to use a starter having a low molar mass is a distinct advantage over the use of oligomeric starters prepared by means of a preceding oxyalkylation. In particular an economic viability is achieved which is made possible by the omission of a separate oxyalkylation process.

Groups active in respect of the alkoxylation and having active hydrogen atoms are, for example, —OH, —NH₂ (primary amines), —NH— (secondary amines), —SH and —CO₂H, preferably —OH and —NH₂, more preferably —OH. H-functional starter substance used are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule. The C₁-C₂₄ alkyl fatty acid esters containing an average of at least 2 OH groups per molecule are for example commercial products such as Lupranol Balance® (from BASF AG), Merginol® products (from Hobum Oleochemicals GmbH), Sovermol® products (from Cognis Deutschland GmbH & Co. KG) and Soyol®TM products (from USSC Co.).

Monofunctional starter substances that may be employed include alcohols, amines, thiols and carboxylic acids. Employable monofunctional alcohols include: methanol, ethanol, 1-propanol, 2-propanol, 1-butanol, 2-butanol, tert-butanol, 3-buten-1-ol, 3-Butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Contemplated monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols suitable as H-functional starter substances are, for example, dihydric alcohols (for example ethylene glycol, diethylene glycol, propylene glycol, dipropylene glycol, 1,3-propanediol, 1,4-butanediol, 1,4-butenediol, 1,4-butynediol, neopentyl glycol, 1,5-pentanediol, methylpentanediols (such as, for example, 3-methyl-1,5-pentanediol), 1,6-hexanediol, 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil).

The H-functional starter substances may also be selected from the substance class of the polyether polyols having a molecular weight Mₙ in the range from 58 to 4500 g/mol and a functionality of 2 to 3. Preference is given to polyether polyols made up of repeating ethylene oxide and propylene oxide units, preferably having a proportion of 35% to 100% of propylene oxide units, particularly preferably having a proportion of 50% to 100% of propylene oxide units. These may be random copolymers, gradient copolymers, alternating copolymers or block copolymers of ethylene oxide and propylene oxide.

The H-functional starter substances may also be selected from the substance class of the polyester polyols. At least bifunctional polyesters are used as the polyester polyols. Polyester polyols preferably consist of alternating acid and alcohol units. Acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter substances for preparing the polyether ester polyols.

In a further embodiment of the invention, polyether carbonate polyols may be used as H-functional starter substances. To this end these polyether carbonate polyols used as H-functional starter substances are produced beforehand in a separate reaction step.

The H-functional starter substances generally have a functionality (i.e. number of hydrogen atoms that are active for the polymerization per molecule) of 1 to 8, preferably of 2 or 3. The H-functional starter substances are used either individually or as a mixture of at least two H-functional starter substances.

It is particularly preferable when the H-functional starter substances are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol and polyether polyols having a molecular weight Mn in the range from 150 to 4500 g/mol and a functionality of 2 to 3.

The polyether carbonate polyols are prepared by catalytic addition of carbon dioxide and alkylene oxides onto H-functional starter substances. In the context of the invention “H-functional” is understood to mean the number of alkoxylation-active hydrogen atoms per molecule of the starter substance.

H-functional starter compounds that may be employed further include polycarbonate diols, in particular those having a molecular weight Mn in the range from 150 to 4500 g/mol, preferably 500 to 2500 g/mol, prepared, for example, by reaction of phosgene, dimethyl carbonate, diethyl carbonate or diphenyl carbonate and difunctional alcohols or polyester polyols or polyether polyols. Examples for polycarbonates may be found for example in EP-A 1359177. Employable polycarbonate diols include for example the Desmophen® C-products from Covestro AG, for example Desmophen® C 1100 or Desmophen® C 2200.

A further embodiment of the invention may employ polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols as H-functional starter compounds. In particular, polyether carbonate polyols, polycarbonate polyols and/or polyether ester carbonate polyols may be obtained by reaction of alkylene oxides, preferably ethylene oxide, propylene oxide or mixtures thereof, optionally further comonomers, with CO2 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO2 may be found for example in Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter compounds may be prepared beforehand in a separate reaction step.

In a preferred embodiment of the process the 4-membered ring lactone is one or more compound(s) selected from the group consisting of propiolactone, β-butyrolactone, β-isovalerolactone, β-caprolactone, β-isocaprolactone, β-methyl-β-valerolactone, diketene, preferably propiolactone and β-butyrolactone and more preferably propiolactone.

DMC catalysts for use in the homopolymerization of alkylene oxides are known in principle from the prior art (see, for example, U.S. Pat. Nos. 3,404,109, 3,829,505, 3,941,849 and 5,158,922). DMC catalysts, as described for example in U.S. Pat. No. 5,470,813, EP-A 700 949, EP-A 743 093, EP-A 761 708, WO 97/40086, WO 98/16310 and WO 00/47649, have a very high activity and enable the preparation of polyether carbonate polyols at very low catalyst concentrations so that a removal of the catalyst from the finished product is generally no longer required. A typical example is that of the highly active DMC catalysts described in EP-A 700 949 which contain not only a double metal cyanide compound (e.g. zinc hexacyanocobaltate(III)) and an organic complex ligand (e.g. tert-butanol) but also a polyether having a number-average molecular weight greater than 500 g/mol.

The DMC catalysts according to the invention are preferably obtained by
(i) reacting an aqueous solution of a metal salt with the aqueous solution of a metal cyanide salt in the presence of one or more organic complex ligands, e.g. an ether or alcohol, in a first step,
(ii) removing the solid from the suspension obtained from (i) by known techniques (such as centrifugation or filtration) in a second step,
(iii) optionally washing the isolated solid with an aqueous solution of an organic complex ligand (for example by resuspending and subsequent reisolating by filtration or centrifugation) in a third step,
(iv) and subsequently drying the solid obtained at temperatures of in general 20-120° C. and at pressures of in general 0.1 mbar to atmospheric pressure (1013 mbar), optionally after pulverizing,

wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts according to the invention are the reaction products of water-soluble metal salts and water-soluble metal cyanide salts.

For example, an aqueous solution of zinc chloride (preferably in excess based on the metal cyanide salt, for example potassium hexacyanocobaltate) and potassium hexacyanocobaltate are mixed and dimethoxyethane (glyme) or tert-butanol (preferably in excess based on zinc hexacyanocobaltate) is then added to the suspension formed.

Metal salts suitable for preparation of the double metal cyanide compounds preferably have the general formula (II)

M(X)ₙ (II)

wherein

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni^{2±},

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 when X=sulfate, carbonate or oxalate and

n is 2 when X=halide, hydroxide, carboxylate, cyanate, thiocyanate, isocyanate, isothiocyanate or nitrate,

or suitable metal salts have the general formula (III)

Mᵣ(X)₃ (III)

wherein

M is selected from the metal cations Fe³⁺, Al³⁺, Co³⁺ and Cr³⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 when X=sulfate, carbonate or oxalate and

r is 1 when X=halide, hydroxide, carboxylate, cyanate, thiocyanate, isocyanate, isothiocyanate or nitrate,

or suitable metal salts have the general formula (IV)

M(X)ₛ (IV)

wherein

M is selected from the metal cations Mo⁴⁺, V⁴⁺ and W⁴⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 when X=sulfate, carbonate or oxalate and

s is 4 when X=halide, hydroxide, carboxylate, cyanate, thiocyanate, isocyanate, isothiocyanate or nitrate,

or suitable metal salts have the general formula (V)

M(X)ₜ (V)

wherein

M is selected from the metal cations Mo⁶⁺ and W⁶⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 when X=sulfate, carbonate or oxalate and

t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have the general formula (VI)

(Y)ₐM′(CN)_{b}(A)_{c} (VI)

wherein

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate and

a, b and c are integers, wherein the values for a, b and c are selected so as to ensure electronic neutrality of the metal cyanide salt; a is preferably 1, 2, 3 or 4; b is preferably 4, 5 or 6; c preferably has the value of 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts according to the invention are compounds of the general formula (VII)

Mₓ[M′ₓ,(CN)_{y}]_{z} (VII)

where M is as defined in formula (II) to (V) and

M′ is as defined in formula (VI), and

x, x′, y and z are integers and are selected such as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The organic complex ligands given greatest preference are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

Optionally employed in the preparation of the DMC catalysts according to the invention are one or more complex-forming component(s) from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ethers, polyvinyl ethyl ethers, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethyl cellulose and polyacetals, or of the glycidyl ethers, glycosides, carboxylic esters of polyhydric alcohols, gallic acids or salts, esters or amides thereof, cyclodextrins, phosphorus compounds, α,β-unsaturated carboxylic esters or ionic surface- or interface-active compounds.

In the preparation of the DMC catalysts according to the invention in the first step the aqueous solutions of the metal salt (e.g. zinc chloride), preferably employed in a stoichiometric excess (at least 50 mol %) based on metal cyanide salt (i.e. at least a molar ratio of metal salt to metal cyanide salt of 2.25:1.00), and of the metal cyanide salt (e.g. potassium hexacyanocobaltate) are reacted in the presence of the organic complex ligand (e.g. tert-butanol) to form a suspension comprising the double metal cyanide compound (e.g. zinc hexacyanocobaltate), water, excess metal salt and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the metal salt and the metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand. A preferred process for performing the first step (i.e. the preparation of the suspension) is effected using a mixing nozzle, particularly preferably using a jet disperser, as described in WO-A 01/39883.

In the second step, the solid (i.e. the precursor of the catalyst of the invention) is isolated from the suspension by known techniques, such as centrifugation or filtration.

In a preferred variant of the embodiment, the isolated solid is then washed with an aqueous solution of the organic complex ligand (for example by resuspension and subsequent reisolation by filtration or centrifugation) in a third process step. This makes it possible to remove, for example, water-soluble by-products such as potassium chloride from the inventive catalyst. The amount of the organic complex ligand in the aqueous wash solution is preferably between 40% and 80% by weight, based on the overall solution.

Further complex-forming component is optionally added to the aqueous wash solution in the third step, preferably in the range between 0.5% and 5% by weight, based on the overall solution.

It is moreover advantageous to wash the isolated solid more than once. Preferably, in a first washing step (iii-1), an aqueous solution of the unsaturated alcohol is used for washing (for example by resuspension and subsequent reisolation by filtration or centrifugation), in order in this way to remove, for example, water-soluble by-products such as potassium chloride from the inventive catalyst. The amount of the unsaturated alcohol in the aqueous washing solution is particularly preferably between 40% and 80% by weight, based on the overall solution of the first washing step. In the further washing steps (iii-2), either the first washing step is repeated one or more times, preferably one to three times, or, preferably, a nonaqueous solution, for example a mixture or solution of unsaturated alcohol and further complex-forming component (preferably in the range between 0.5% and 5% by weight, based on the total amount of the wash solution in step (iii-2)), is used as a washing solution, and the solid is washed with it one or more times, preferably one to three times.

The isolated and optionally washed solid is subsequently dried, optionally after pulverization, at temperatures of generally 20-100° C. and at pressures of generally 0.1 mbar to standard pressure (1013 mbar).

A preferred process for isolation of the DMC catalysts according to the invention from the suspension by filtration, filtercake washing and drying is described in WO-A 01/80994.

The polyether ester polyols obtainable by the process according to the invention have a low content of by-products and can be processed without difficulty, especially by reaction with di- and/or polyisocyanates to afford polyurethanes, in particular flexible polyurethane foams. For polyurethane applications, it is preferable to employ polyether ester polyols based on an H-functional starter substance having a functionality of at least 2. In addition, the polyether ester polyols obtainable by the process according to the invention may be used in applications such as washing and cleaning composition formulations, drilling fluids, fuel additives, ionic and nonionic surfactants, lubricants, process chemicals for papermaking or textile manufacture, or cosmetic formulations. The person skilled in the art is aware that the polyether ester polyols to be used have to fulfill certain physical properties, for example molecular weight, viscosity, functionality and/or hydroxyl number, depending on the particular field of application.

The polyisocyanate may be an aliphatic or aromatic di- or polyisocyanate. Examples include 1,4-butylene diisocyanate, 1,5-pentane diisocyanate, 1,6-hexamethylene diisocyanate (HDI) and dimers, trimers, pentamers, heptamers or nonamers or mixtures thereof, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C1 to C6-alkyl groups. An isocyanate from the diphenylmethane diisocyanate series is preferred here.

In addition to the abovementioned polyisocyanates, it is also possible to use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

In a first embodiment, the invention relates to a process for preparing a polyether ester polyol by addition of alkylene oxide and lactone onto H-functional starter substance in the presence of a double metal cyanide catalyst, characterized in that

(α) a suspension medium containing no H-functional groups is initially charged in a reactor and

(γ) H-functional starter substance is continuously metered into the reactor over the course of the reaction and wherein the lactone is a 4-membered ring lactone.

In a second embodiment, the invention relates to a process according to the first embodiment, wherein in step (α) a suspension medium containing no H-functional groups is initially charged in the reactor and no H-functional starter substance is initially charged in the process in the reactor.

In a third embodiment, the invention relates to a process according to the first embodiment, wherein in step (α) a suspension medium containing no H-functional groups and additionally a portion of the H-functional starter substance are initially charged in the reactor.

In a fourth embodiment, the invention relates to a process according to any of the first to third embodiments, wherein in step (α) a suspension medium containing no H-functional groups is initially charged in the reactor together with DMC catalyst.

In a fifth embodiment, the invention relates to a process according to the fourth embodiment, wherein after step (α)
(β) a portion of alkylene oxide or a mixture of alkylene oxide and lactone is added to the mixture from step (α) at temperatures of 90° C. to 150° C. and wherein the addition of the alkylene oxide compound is then interrupted.

In a sixth embodiment, the invention relates to a process according to the embodiment, wherein in step (β) a mixture of alkylene oxide and lactone is added and the proportion of the lactone is 1% by weight to 80% by weight, preferably 3% by weight to 60% by weight and more preferably 22% by weight to 40% by weight based on the total mass of alkylene oxide and lactone metered in step (β).

In a seventh embodiment, the invention relates to a process according to any of the first to sixth embodiments, wherein in step (γ) H-functional starter substance, alkylene oxide and lactone are metered in continuously (“copolymerisation”).

In an eighth embodiment, the invention relates to a process according to any of the first to sixth embodiments, wherein in step (γ) the metered addition of the H-functional starter substance is terminated prior to the addition of the alkylene oxide.

In a ninth embodiment, the invention relates to a process according to the eighth embodiment, wherein in step (γ) a mixture of alkylene oxide and lactone is added and the proportion of the lactone is 1% by weight to 80% by weight, preferably 3% by weight to 60% by weight and more preferably 22% by weight to 40% by weight based on the total mass of alkylene oxide and lactone metered in step (γ).

In a tenth embodiment, the invention relates to a process according to any of the first to ninth embodiments, wherein the 4-membered ring lactone is one or more compound(s) and is selected from the group consisting of propiolactone, β-butyrolactone, β-isovalerolactone, β-caprolactone, isocaprolactone, β-methyl-β-valerolactone, diketene, preferably propiolactone and β-butyrolactone.

In an eleventh embodiment, the invention relates to a process according to any of the eighth to tenth embodiments, wherein in step (γ) DMC catalyst is continuously metered into the reactor and the resulting reaction mixture is continuously removed from the reactor.

In a twelfth embodiment, the invention relates to a process according to the eighth embodiment, wherein the DMC catalyst is continuously added in the form of a suspension in H-functional starter substance.

In a thirteenth embodiment, the invention relates to a process according to the eleventh or twelfth embodiment, wherein (δ) the reaction mixture continuously removed in step (γ) having a content of 0.05% by weight to 10% by weight of alkylene oxide is transferred into a postreactor in which, by way of a postreaction, the content of free alkylene oxide is reduced to less than 0.05% by weight in the reaction mixture.

In a fourteenth embodiment, the invention relates to a process according to any of the first to thirteenth embodiments, wherein the suspension medium used in step (α) is one or more compound(s) selected from the group consisting of 4-methyl-2-oxo-1,3-dioxolane, 1,3-dioxolan-2-one, acetone, methyl ethyl ketone, acetonitrile, nitromethane, dimethyl sulfoxide, sulfolane, dimethylformamide, dimethylacetamide, N-methylpyrrolidone, dioxane, diethyl ether, methyl tert-butyl ether, tetrahydrofuran, ethyl acetate, butyl acetate, pentane, n-hexane, benzene, toluene, xylene, ethylbenzene, chloroform, chlorobenzene, dichlorobenzene and carbon tetrachloride.

In a fifteenth embodiment, the invention relates to a process of the fourteenth embodiment, wherein the suspension medium used is one or more compound(s) selected from the group consisting of 4-methyl-2-oxo-1,3-dioxolane and 1,3-dioxolan-2-one or a mixture of 4-methyl-2-oxo-1,3-dioxolane and 1,3-dioxolan-2-one.

In a sixteenth embodiment, the invention relates to a process according to any of the first to fifteenth embodiments, wherein the H-functional starter substance suspension medium is one or more compound(s) selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, octane-1,8-diol, diethylene glycol, dipropylene glycol, glycerol, trimethylolpropane, pentaerythritol, sorbitol and polyether polyols having a molecular weight Mn in the range from 150 to 4500 g/mol and a functionality of 2 to 3.

In a seventeenth embodiment, the invention relates to a process according to the sixteenth embodiment, wherein the H-functional starter substance suspension medium is one or more compound(s) selected from the group consisting of ethylene glycol, propylene glycol, trimethylolpropane and glycerol.

In an eighteenth embodiment, the invention relates to a process according to any of the first to seventeenth embodiments, wherein the DMC catalyst is employed in an amount such that the content of DMC catalyst in the resulting reaction product is 10 to 10 000 ppm, more preferably 20 to 5000 ppm and most preferably 50 to 2000 ppm.

In a nineteenth embodiment, the invention relates to a polyether ester polyol obtainable according to at least one of the first to eighteenth embodiments.

In a twentieth embodiment, the invention relates to a process for producing polyurethanes obtainable by reaction of
i) polyether ester polyols according to any of the nineteenth embodiment with
ii) polyisocyanates.

In a twenty-first embodiment, the invention relates to a process for producing polyurethanes according to the twentieth embodiment, wherein the polyisocyanate is one or more compound(s) selected from the group consisting of 1,4-butylene diisocyanate, 1,5-pentane diisocyanate, 1,6-hexamethylene diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, the isomeric bis(4,4′-isocyanatocyclohexyl)methanes or mixtures thereof having any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanato-prop-2-yl)benzene (TMXDI), 1,3-bis(isocyanatomethyl)benzene (XDI), and alkyl 2,6-diisocyanatohexanoate (lysine diisocyanates) having C1 to C6 alkyl groups.

In a twenty-second embodiment, the invention relates to a process for producing polyurethanes according to the twenty-first embodiment, wherein the polyisocyanate is one or more compound(s) selected from the group consisting of 2,4-tolylene diisocyanate, 2,6-tolylene diisocyanate (TDI), 2,2′-diphenylmethane diisocyanate, 2,4′-diphenylmethane diisocyanate, 4,4′-diphenylmethane diisocyanate (MDI).

### EXAMPLES

Starting Materials Used

Propylene glycol (purity >99.5%, Sigma-Aldrich Chemie GmbH)

Propylene oxide (purity >99.5%, Sigma-Aldrich Chemie GmbH)

β-Propiolactone (97%, Acros Organics BVBA)

β-Butyrolactone (purity 98%, Sigma-Aldrich Chemie GmbH)

ε-Caprolactone (purity 97%, Sigma-Aldrich Chemie GmbH)

The DMC catalyst used in all examples was DMC catalyst prepared according to example 6 in WO 01/80994 A1.

Description of the Methods:

Gel permeation chromatography (GPC): Measurements were performed on an Agilent 1200 Series (G1311A Bin Pump, G1313A ALS, G1362A RID), detection by RID; eluent: tetrahydrofuran (GPC grade), flow rate 1.0 ml/min at 40° C.; column temperature; column combination: 2×PSS SDV precolumn 100 Å (5 μm), 2×PSS SDV 1000 Å (5 μm). Calibration was carried out using Poly(styrene) ReadyCal-Kit low in the range Mp=266-66000 Da from “PSS Polymer Standards Service”. The measurement recording and evaluation software used was the “PSS WinGPC Unity” software package.

¹H NMR

The composition of the polymer was determined by ¹H NMR (Bruker DPX 400, 400 MHz; pulse program zg30, relaxation time D1: 10s, 64 scans). Each sample was dissolved in deuterated chloroform. The relevant resonances in the ¹H NMR (based on TMS=0 ppm) and the assignment of the area integrals (A) are as follows:
cyclic propylene carbonate (cPC), solvent, resonance at 4.5 ppm, area integral corresponds to one hydrogen atom;
unreacted monomeric propylene oxide (PO), resonance at 2.4 and 2.8 ppm, each area integral corresponds to one hydrogen atom;
polypropylene oxide (PPO), PO homopolymer, resonances at 1.0 to 1.2 ppm, area integral minus portion of PPL-PPO moiety (1.5*A(PPL-PPO)) corresponds to 3 hydrogen atoms;
polypropiolactone (PPL-PPL), resonance at 4.4 ppm, area integral corresponds to 2 hydrogen atoms;
polypropiolactone (PPL-PPO), resonance at 2.6 ppm, area integral minus 2 hydrogen atoms from the PPL-PPL repeating unit corresponds to 2 hydrogen atoms;
beta-butyrolactone (BL), resonance at 1.6 ppm, area integral minus 3 hydrogen atoms of cPC corresponds to 3 hydrogen atoms;
beta-propiolactone (PL), resonance at 4.28 and 3.54, each area integral corresponds to 2 hydrogen atoms;
polybutyrolactone (PBL-PBL), resonance at 2.4-2.7 ppm, area integral corresponds to 2 hydrogen atoms;
polypropiolactone (PBL-PPO), resonance at 2.4 ppm, area integral corresponds to 2 hydrogen atoms,
epsilon-caprolactone (CL), resonance at 4.3 ppm, area integral corresponds to 2 hydrogen atoms;
polycaprolactone (PCL), resonance at 2.3 ppm, area integral corresponds to 2 hydrogen atoms;

This gives the following mole fractions (x) for the respective components:
x(cPC)=A (4.5 ppm)
x(PO)=A (2.75 ppm) or A (2.4 ppm)
x(PPO)=A (1.0-1.2 ppm)/3
x(PPL-PPL)=A(PPL-PPL)/2
x(PPL-PPO)=A(PPL-PPO)/2
x(BL)=A(BL)/3
x(PL)=A(PL)/2
x(PBL-PBL)=A(PBL-PBL)/2
x(PBL-PPO)=A(PBL-PPO)/2
x(CL)=A(CL)/2
x(PCL)=A(PCL)/2

The percentage mole fraction is calculated by dividing the mole fraction (x) of the respective component by the sum of the mole fractions present in the sample. The weight fraction is also calculated by multiplying the mole fractions (x) by the accompanying molar masses and dividing by the sum of the weight fractions present. The following molar masses (g/mol) are used for converting the weight fractions: cPC=102, PO and PPO=58, BL=86, PL=72, CL=PCL=114, PPL-PPO=130, PBL-PPO=144, PCL-PPO=172.

### Example 1: Preparation of Polyether Ester Polyol with Initial Charging of cPC as the Suspension Medium and Continuous Metered Addition of Propylene Glycol as the H-Functional Starter Substance and β-Propiolactone as the Lactone

Step α:

100 mg of dried unactivated DMC catalyst were suspended in 50.0 g of 4-methyl-2-oxo-1,3-dioxolane (also referred to hereinafter as cyclic propylene carbonate or cPC) in a 0.3 L pressure reactor fitted with a gas metering unit. The reactor was sealed and inertized by threefold pressurization with 20 bar of N2 and subsequent decompression to 5 bar.

Step β:

In the reactor at 130° C., 500 rpm and at a supply pressure of 5 bar established with nitrogen, an amount of 10 g of a mixture of β-propiolactone (10% by weight) in propylene oxide was added all at once. Onset of the reaction was indicated by a temperature peak (“hotspot”) and by a pressure drop to the starting pressure. The procedure was carried out twice in total.

Step γ:

After activation, 76.20 g of a mixture of β-propiolactone (30% by weight) in propylene oxide at 1 g/min and at the same time 38.05 g of a mixture of propylene glycol (10% by weight) in propylene carbonate at 1 g/min are simultaneously metered into the reactor. Once addition was complete the mixture was stirred at 130° C. until the exothermic reaction had abated and until a constant pressure was reached. The average molecular weight (determined by gel permeation chromatography) is reported in table 1.

### Example 2: Preparation of Polyether Ester Polyol with Initial Charging of cPC as the Suspension Medium and Continuous Metered Addition of Propylene Glycol as the H-Functional Starter Substance and β-Butyrolactone as the Lactone

Preparation of the polyether ester polyol was performed as per example 1, but employing a mixture of β-butyrolactone (30% by weight) in propylene oxide in step β and γ. The results are reported in table 1.

### Example 3 (Comparative): Preparation of Polyether Ester Polyol with Initial Charging of cPC as the Suspension Medium and Continuous Metered Addition of Propylene Glycol as the H-Functional Starter Substance and ε-Caprolactone as the Lactone

Preparation of the polyether ester polyol was performed as per example 1, but employing a mixture of ε-caprolactone (30% by weight) in propylene oxide in step β and γ.

The results are reported in table 1.

### Example 4: Preparation of Polyether Ester Polyol with Initial Charging of cPC as the Suspension Medium and Continuous Metered Addition of Propylene Glycol as the H-Functional Starter Substance and β-Propiolactone as the Lactone

Preparation of the polyether ester polyol was performed as per example 1, but employing a mixture of β-propiolactone (5% by weight) in propylene oxide in step β and γ. The results are reported in table 1.

### Example 5: Preparation of Polyether Ester Polyol with Initial Charging of cPC as the Suspension Medium and Continuous Metered Addition of Propylene Glycol as the H-Functional Starter Substance and β-Propiolactone as the Lactone

Preparation of the polyether ester polyol was performed as per example 1, but employing a mixture of β-propiolactone (10% by weight) in propylene oxide in step β and γ. The results are reported in table 1.

### Example 6 (Comparative): Preparation of Polyether Ester Polyol with Initial Charging of Propylene Glycol as the H-Functional Starter Substance and β-Propiolactone as the Lactone

Step α:

100 mg of dried unactivated DMC catalyst were suspended in 50 g of 4-methyl-2-oxo-1,3-dioxolane (also referred to hereinafter as cyclic propylene carbonate or cPC) and 3.805 g of monopropylene glycol (MPG) in a 0.3 L pressure reactor fitted with a gas metering unit. The reactor was sealed and inertized by threefold pressurization with 20 bar of N₂ and subsequent decompression to 5 bar.

Step β:

In the reactor at 130° C., 500 rpm and at a supply pressure of 5 bar established with nitrogen, an amount of 10 g of a mixture of β-propiolactone (10% by weight) in propylene oxide was added all at once. No reaction such as would be indicated by a temperature increase and a pressure reduction in the reactor was apparent after addition of the propylene oxide. Even addition of a second portion of PO (10 g) did not lead to onset of a reaction. The polyester ether polyol was not producible in this way.

TABLE 1
Conversion of lactone and molecular weight of the polyether ester polyols

| | | Lactone | | | |
|---|---|---|---|---|---|
| | | proportion | | | |
| | | in step (β)/ | | | x |
| | | (γ) [% by | X(lactone) | Mₙ | (lactone) |
| Example | Lactone | weight]^{a)} | [%] | [g/mol] | [mol %] |
| 1 | β- | 30/30 | 100 | 1845 | 22.5 |
| | propiolactone | | | | |
| 2 | β- | 30/30 | 82 | 2089 | 14.5 |
| | butyrolactone | | | | |
| 3 | ε- | 30/30 | 21 | 1975 | 3.0 |
| (comparative) | caprolactone | | | | |
| 4 | β- | 5/5 | 100 | 1945 | 3.6 |
| | propiolactone | | | | |
| 5 | β- | 10/10 | 100 | 1856 | 6.9 |
| | propiolactone | | | | |
| 6 | β- | 30/30 | n.d. | n.d. | n.d. |
| (comparative) | propiolactone | | | | |

^{a)}calculated lactone proportion metered in in step (β)/(γ) based on the sum of lactone and alkylene oxide in % by weight in step (β)/(γ).

The results for preparing polyether ester polyols are summarized in table 1. The process according to the invention was used to prepare polyether ester polyols by copolymerization of an alkylene oxide with a lactone by adding 5% by weight (entry 4), 10% by weight (entry 5) and 30% by weight (entry 1) of lactone. The results show that through continuous metered addition of the H-functional starter substance the 4-ring lactones show an improved incorporation rate and conversion rate compared to the prior art and compared to higher lactones such as ε-caprolactone (comparative example 3). Initial charging of the H-functional starter substance resulted in no polyether ester polyol being obtainable (comparative example 6).

1. A process for preparing a polyether ester polyol by addition of alkylene oxide and lactone onto H-functional starter substance in the presence of a double metal cyanide catalyst, comprising:
(α) initially charging a suspension medium containing no H-functional groups in a reactor; and
(γ) continuously metering H-functional starter substance into the reactor over the course of the reaction and
wherein the lactone is a 4-membered ring lactone.

2. The process as claimed in claim 1, wherein in step (α) a suspension medium containing no H-functional groups is initially charged in the reactor and no H-functional starter substance is initially charged in the reactor.

3. The process as claimed in claim 1, wherein in step (α) a suspension medium containing no H-functional groups and additionally a portion of the H-functional starter substance are initially charged in the reactor.

4. The process as claimed in claim 1, wherein in step (α) a suspension medium containing no H-functional groups is initially charged in the reactor together with DMC catalyst.

5. The process as claimed in claim 4, wherein after step (α)
(β) a portion of alkylene oxide or a mixture of alkylene oxide and lactone is added to the mixture from step (α) at a temperature of 90° C. to 150° C. and wherein the addition of the alkylene oxide compound is then interrupted.

6. The process as claimed in claim 5, wherein in step (β) a mixture of alkylene oxide and lactone is added and the proportion of the lactone is 1% by weight to 80% by weight, based on the total mass of alkylene oxide and lactone metered in step (β).

7. The process as claimed in claim 1, wherein in step (γ) H-functional starter substance, alkylene oxide and lactone are metered in continuously.

8. The process as claimed in claim 1, wherein in step (γ) the metered addition of the H-functional starter substance is terminated prior to the addition of the alkylene oxide.

9. The process as claimed in claim 8, wherein in step (γ) a mixture of alkylene oxide and lactone is added and the proportion of the lactone is 1% by weight to 80% by weight, based on the total mass of alkylene oxide and lactone metered in step (γ).

10. The process as claimed in claim 1, wherein the 4-membered ring lactone comprises at least one of propiolactone, β-butyrolactone, β-isovalerolactone, β-caprolactone, β-isocaprolactone, β-methyl-β-valerolactone, and diketene.

11. A polyether ester polyol obtained by the process as claimed in claim 1.

12. A process for producing polyurethanes comprising reacting
i) the polyether ester polyol as claimed in claim 11 with
ii) a polyisocyanate.
